(19) United States
(12) Patent Application Publication
(10) Pub. No.: US 2025/0089700 A1
(43) Pub. Date: Mar. 20, 2025

(54) Snake Deterrent Device

(71) Applicants: Mark Bero, Brownville, NY (US); Anita Bero, Brownville, NY (US)

(72) Inventors: Mark Bero, Brownville, NY (US); Anita Bero, Brownville, NY (US)

(21) Appl. No.: 18/675,353

(22) Filed: May 28, 2024

Related U.S. Application Data
(60) Provisional application No. 63/583,664, filed on Sep. 19, 2023.

(51) Int. Cl. A01M 29/30; A01M 29/14

(52) U.S. Cl. CPC A01M 29/30; A01M 29/14

(57) ABSTRACT

A snake deterrent device is provided. The device is comprised of a base comprised of at least one cooling element that cools at least one top plate. The element is preferably cooling tubing that cools the top plate at or below 50 degrees Fahrenheit, wherein the top plate is comprised of a conductive material. In this manner, the plate is cooled such that if a snake attempts to pass over the plate, the cooled temperature of the plate discourages the snake from entering into the structure or area.

### CROSS-REFERENCE TO RELATED APPLICATION

The present application claims priority to, and the benefit of, U.S. Provisional Application No. 63/583,664, which was filed on Sep. 19, 2023, and is incorporated herein by reference in its entirety.

### FIELD OF THE INVENTION

The present invention relates generally to the field of animal deterrents. More specifically, the present invention relates to a snake deterrent device that can be placed in or on a doorway or within a structure to deter snakes from entering the structure via a cooled top plate that the snake must pass over. Accordingly, the present disclosure makes specific reference thereto. Nonetheless, it is to be appreciated that aspects of the present invention are also equally applicable to other like applications, devices, and methods of manufacture.

### BACKGROUND

Snakes are ectothermic creatures and rely on external sources to regulate their body temperature. Consequently, they are instinctively attracted to warmer areas, especially when faced with colder seasons or when residing in cooler climates. As a result, snakes are always in search of areas and structures that allow them to optimally maintain their body temperature, ensuring their survival and overall well-being.

As a result, snakes often find their way into various structures such as buildings, homes, barns, and other enclosed spaces. Their presence (or even the possibility of their presence) in said areas can induce a sense of unease and heightened anxiety among residents. This is particularly true for individuals who are particularly afraid of snakes. This concern is further amplified when considering the well-being of children and pets. Their innate curiosity, combined with a lack of awareness about the dangers snakes pose, makes them particularly susceptible to snake bites. Such encounters can result in grave injuries, and in certain unfortunate instances, can even prove fatal.

Given the potential threat they represent, it's understandable that many individuals desire methods to prevent snakes from infiltrating their living spaces. Common methods may include poisoning, traps, or other harmful or fatal methods. However, some individuals may wish to deter snakes without harming or killing snakes.

Therefore, there exists a long-felt need in the art for a device that can be used to deter snakes. There also exists a long-felt need in the art for a device that can be used to deter snakes from entering into specific areas. Further, there exists a long-felt need in the art for a snake deterrent device that can be used to deter snakes from entering into an area, home, garage, barn, or other structure. More specifically, there exists a long-felt need in the art for a snake deterrent device that can be used to deter snakes from entering into an area, home, garage, barn, or other structure via the use of cooling and without harming the snake.

The subject matter disclosed and claimed herein, in one embodiment thereof, comprises a snake deterrent device. The device is comprised of a base comprised of at least one cooling element that cools at least one top plate. The element is preferably cooling tubing that cools the top plate at or below 50 degrees Fahrenheit, wherein the top plate is comprised of a conductive material. In this manner, the plate is cooled such that if a snake attempts to pass over the plate, the cooled temperature of the plate discourages the snake from entering into the structure or area.

In this manner, the snake deterrent device of the present invention accomplishes all the foregoing objectives and provides a device that can be used to deter snakes from entering into specific areas such as a home, garage, barn, or other structure. More specifically, the device does so with the use of cooling. This naturally deters snakes in a manner that does not harm the snakes.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a snake deterrent device. The device is comprised of a base with at least one cooling element and a top plate that covers the base. The device can be placed before, in, after, etc., a doorway or other location outside or inside a structure such as, but not limited to, a home, a garage, a barn, etc. The cooling element cools the plate such that any snake that contacts the plate will be discouraged from crossing over the plate into the structure due to the temperature of the plate.

The base is comprised of an interior space. At least one cooling element is positioned within the interior space and is preferably a cooling tubing having any type of coolant circulating through the tubing. The cooling element preferably cools below 50 degrees Fahrenheit, but may cool to any temperature in different embodiments. In one embodiment, the bottom surface of the base is comprised of a non-slip material such as, but not limited to, rubber that prevents the base from sliding if stepped on.

The device is also comprised of at least one top plate that covers the interior space. The top plate is preferably comprised of a conductive metal (or other) material of the like which is then cooled by the cooling element such that when a snake attempts to travel over the top plate the snake will contact the cold top plate surface and will be discouraged from traveling over the plate through the doorway. To further improve the cooling of the plate, the plate may be comprised of at least one baffle and/or opening that improves the circulation of cooled air from the cooling element.

The present invention is also comprised of a method of using the device. First, a device is provided comprised of a base comprised of at least one cooling element and a top plate received by the base. Then, the cooling element can be turned on and set to a cooling temperature via a button. Next, the device can be placed on, in, in front of, or behind a doorway or other area of a structure.

The present invention is also comprised of a method of using the device. First, a device is provided comprised of a base comprised of at least one cooling element and a top plate received by the base. Then, the cooling element can be turned on and set to a cooling temperature via a button. Next, the device can be placed on, in, in front of, or behind a doorway or other area of a structure. Then, at least one fastener can be placed through at least one receiving area of the base to secure the device in position to a doorway or other area.

Accordingly, the snake deterrent device of the present invention is particularly advantageous as it provides a device that can be used to deter snakes from entering into specific areas such as a home, garage, barn, or other structure. More specifically, the device does so with the use of cooling. This naturally deters snakes in a manner that does not harm the snakes. In this manner, the snake deterrent device provides a solution to deterring snakes from specific areas without poisoning, killing, or otherwise injuring said snakes.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a snake deterrent device of the present invention while placed within a doorway in accordance with the disclosed architecture;

FIG. 2 illustrates a perspective view of a base one potential embodiment of a snake deterrent device of the present invention in accordance with the disclosed architecture;

FIG. 3 illustrates a perspective view of one potential embodiment of a snake deterrent device of the present invention in accordance with the disclosed architecture;

FIG. 4 illustrates a flowchart of a method of using one potential embodiment of a snake deterrent device of the present invention in accordance with the disclosed architecture; and

FIG. 5 illustrates a flowchart of a method of using one potential embodiment of a snake deterrent device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that can be used to deter snakes. There also exists a long-felt need in the art for a device that can be used to deter snakes from entering into specific areas. Further, there exists a long-felt need in the art for a snake deterrent device that can be used to deter snakes from entering into an area, home, garage, barn, or other structure. More specifically, there exists a long-felt need in the art for a snake deterrent device that can be used to deter snakes from entering into an area, home, garage, barn, or other structure via the use of cooling and without harming the snake.

The present invention, in one exemplary embodiment, is comprised of a snake deterrent device comprised of a base with at least one cooling element and a top plate that covers the base. The device can be placed before, in, after, etc., a doorway or other location outside or inside a structure such as, but not limited to, a home, a garage, a barn, etc. The cooling element cools the plate such that any snake that contacts the plate will be discouraged from crossing over the plate into the structure due to the temperature of the plate.

The base is comprised of an interior space, wherein at least one cooling element is positioned within the interior space. The cooling element is preferably a cooling tubing having any type of coolant circulating through the tubing. The cooling element preferably cools below 50 degrees Fahrenheit, but may cool to any temperature in different embodiments. In one embodiment, the bottom surface of the base is comprised of a non-slip material such as, but not limited to, rubber that prevents the base from sliding if stepped on.

The device is also comprised of at least one top plate that covers the interior space. The top plate is preferably comprised of a conductive metal (or other) material of the like which is then cooled by the cooling element such that when a snake attempts to travel over the top plate the snake will contact the cold top plate surface and will be discouraged from traveling over the plate through the doorway. To further improve the cooling of the plate, the plate may be comprised of at least one baffle and/or opening that improves the circulation of cooled air from the cooling element.

The present invention is also comprised of a method of using the device. First, a device is provided comprised of a base comprised of at least one cooling element and a top plate received by the base. Then, the cooling element can be turned on and set to a cooling temperature via a button. Next, the device can be placed on, in, in front of, or behind a doorway or other area of a structure.

The present invention is also comprised of a method of using the device. First, a device is provided comprised of a base comprised of at least one cooling element and a top plate received by the base. Then, the cooling element can be turned on and set to a cooling temperature via a button. Next, the device can be placed on, in, in front of, or behind a doorway or other area of a structure. Then, at least one fastener can be placed through at least one receiving area of the base to secure the device in position to a doorway or other area.

Accordingly, the snake deterrent device of the present invention is particularly advantageous as it provides a device that can be used to deter snakes from entering into specific areas such as a home, garage, barn, or other structure. More specifically, the device does so with the use of cooling. This naturally deters snakes in a manner that does not harm the snakes. In this manner, the snake deterrent device provides a solution to deterring snakes from specific areas without poisoning, killing, or otherwise injuring said snakes.

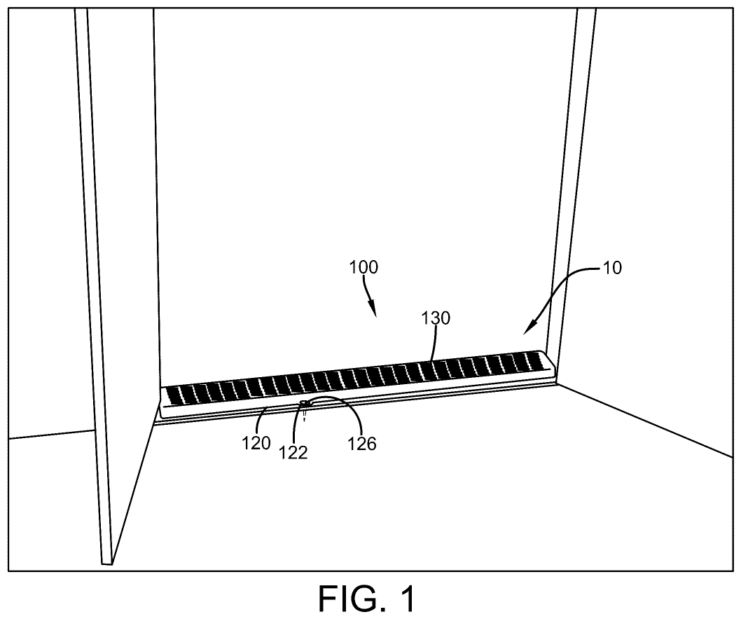

Referring initially to the drawings, FIG. 1 illustrates a perspective view of one potential embodiment of a snake deterrent device 100 of the present invention while placed within a doorway 10 in accordance with the disclosed architecture. The device 100 is comprised of a base 110 with at least one cooling element 114 and a top plate 130 that covers the base 110. The device 100 can be placed before, in, after, etc., a doorway 10, or other location outside or inside a structure such as, but not limited to, a home, a garage, a barn, etc. The cooling element 114 cools the plate 130 such that any snake that contacts the plate 130 will be discouraged from crossing over the plate 130 into the structure due to the temperature of the plate 130.

The base 110 is preferably generally rectangular but may be any shape known in the art. The base 110 is comprised of an interior space 112. At least one cooling element 114 is positioned within the interior space 112. The element 114 may be comprised of at least one cooling tubing having any type of coolant circulating through the tubing. The cooling element 114 preferably cools below 50 degrees Fahrenheit, but may cool to any temperature in different embodiments.

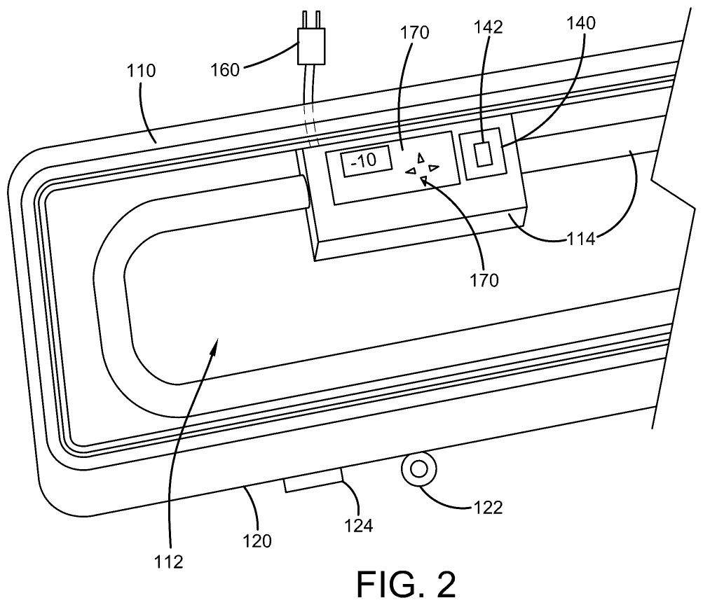

In one embodiment, the temperature of the cooling element 114 is shown on at least one display 172, as seen in FIG. 2. The display 172 may be any type of electronic display known in the art. In one embodiment, the device 100 is comprised of at least one button 170 that allows a user to raise and/or lower the temperature of the element 114 as desired. The display 172 and button 170 may be located anywhere on the device 100.

In one embodiment, the bottom surface 120 of the base 110 is comprised of a non-slip material such as, but not limited to, rubber. The material prevents the base 110 from sliding if stepped on. In one embodiment, the material may be comprised of a raised or recessed texture to further improve grip.

In one embodiment, the bottom surface 120 is comprised of at least one fastener 124. The fastener 124 may further secure the base 110 to a surface or area. The fastener 124 may be any type such as, but not limited to, adhesive, hook and loop, magnet, suction cup, etc.

In another embodiment, the bottom surface 120 is comprised of at least one receiving area 122. The area 122 is preferably in the form of at least one opening or slot. The area 122 can then receive at least one anchoring device 126 such as, but not limited to, a pin. In this manner, the pin 126 can be driven into a ground surface to secure the base 110 in position in front of or on a doorway 10.

It should be appreciated that in different embodiments any portion of the base 110 (not just the bottom surface 120) may be comprised of the fastener 124 and/or receiving area 122.

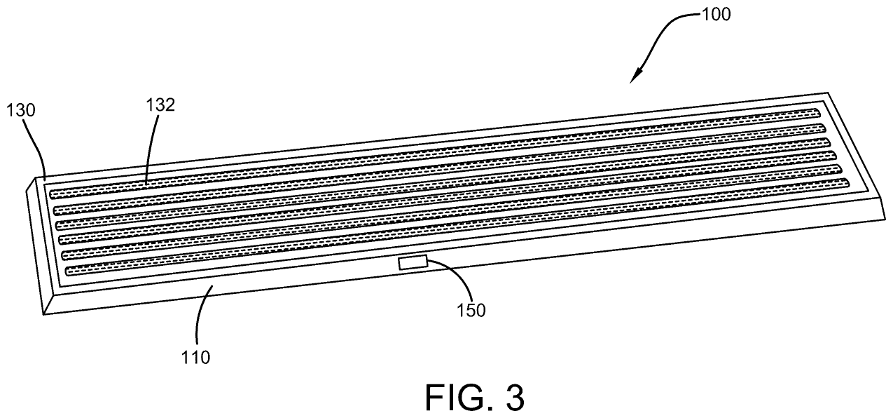

The device 100 is also comprised of at least one top plate 130 that covers the interior space 112, as seen in FIG. 3. The top plate 130 is preferably comprised of a conductive metal (or other) material of the like. The top plate 130 is then cooled by the cooling element 114 such that when a snake attempts to travel over the top plate 130 the snake will contact the cold top plate 130 surface and will be discouraged from traveling over the plate 130 through the doorway 10. To further improve cooling of the plate 130, the plate 130 may be comprised of at least one baffle 132 and/or opening that improves circulation of cooled air from the cooling element 114.

The element 114 is powered by at least one battery 140. In one embodiment, the battery 140 is comprised of a replaceable battery that is disposable or rechargeable. In another embodiment, the battery 140 is non-removable and rechargeable. In one embodiment, the battery 140 may receive power via at least one male or female 110v/220v power cord 160. In another embodiment, the battery 140 is comprised of at least one charging port 142 such as, but not limited to, a USB port. In a further embodiment, the battery 140 is powered by at least one solar panel 150 positioned anywhere on the device 100. The solar panel 150 may be any type known in the art.

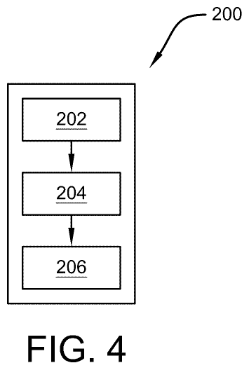

The present invention is also comprised of a method of using 200 the device 100, as seen in FIG. 4. First, a device 100 is provided comprised of a base 110 comprised of at least one cooling element 114 and a top plate 130 received by the base 110 [Step 202]. Then, the cooling element 114 can be turned on and set to a cooling temperature via a button 170 [Step 204]. Next, the device 100 can be placed on, in, in front of, or behind a doorway 10 or other area of a structure [Step 206].

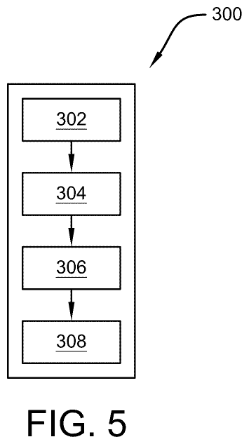

The present invention is also comprised of a method of using 300 the device 100, as seen in FIG. 5. First, a device 100 is provided comprised of a base 110 comprised of at least one cooling element 114 and a top plate 130 received by the base 110 [Step 302]. Then, the cooling element 114 can be turned on and set to a cooling temperature via a button 170 [Step 304]. Next, the device 100 can be placed on, in, in front of, or behind a doorway 10 or other area of a structure [Step 306]. Then, at least one fastener 126 can be placed through at least one receiving area 122 of the base 110 to secure the device 100 in position to a doorway 10 or other area [Step 308].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “snake deterrent device” and “device” are interchangeable and refer to the snake deterrent device 100 of the present invention.

Notwithstanding the foregoing, the snake deterrent device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the snake deterrent device 100 as shown in the FIGS. are for illustrative purposes only, and that many other sizes and shapes of the snake deterrent device 100 are well within the scope of the present disclosure. Although the dimensions of the snake deterrent device 100 are important design parameters for user convenience, the snake deterrent device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A snake deterrent device comprising:
a base comprised of a cooling element and a battery; and
a top plate that attaches to the base.

2. The snake deterrent device of claim 1, wherein the cooling element is comprised of a coolant tube.

3. The snake deterrent device of claim 1, wherein the battery is comprised of a removable battery.

4. The snake deterrent device of claim 1, wherein the battery is comprised of a rechargeable battery.

5. The snake deterrent device of claim 1, wherein the battery is comprised of a charging port.

6. The snake deterrent device of claim 1, wherein the battery is comprised of a power cord.

7. The snake deterrent device of claim 1, wherein the top plate is comprised of an opening.

8. The snake deterrent device of claim 1, wherein the top plate is comprised of a baffle.

9. The snake deterrent device of claim 1, wherein a bottom surface of the base is comprised of a non-slip material.

10. The snake deterrent device of claim 9, wherein the bottom surface is comprised of a raised texture or a recessed texture.

11. A snake deterrent device comprising:
a base comprised of a cooling element, a battery, and a receiving area; and
a top plate that attaches to the base.

12. The snake deterrent device of claim 11, wherein the receiving area is comprised of an opening.

13. The snake deterrent device of claim 11 further comprised of an anchor pin.

14. The snake deterrent device of claim 11, wherein the top plate is comprised of an opening.

15. The snake deterrent device of claim 11, wherein the top plate is comprised of a baffle.

16. The snake deterrent device of claim 11, wherein the cooling element is comprised of a coolant tube.

17. The snake deterrent device of claim 11 further comprised of a solar power that provides power to the battery.

18. The snake deterrent device of claim 11 further comprised of a display that indicates the temperature of the cooling element.

19. The snake deterrent device of claim 11, wherein the temperature of the cooling element can be controlled by a button on the snake deterrent device.

20. A method of using a snake deterrent device, the method comprising the following steps:
providing a snake deterrent device comprised of a base comprised of a cooling element and a top plate that attaches to the base;
turning on the cooling element and setting a cooling temperature of the cooling element via a button; and
placing the snake deterrent device on, in, in front of, or behind a doorway or another area of a structure.
